(19) United States
(12) Patent Application Publication
(10) Pub. No.: US 2024/0367616 A1
(43) Pub. Date: Nov. 7, 2024

(54) WIPER SYSTEM

(71) Applicant: Valeo Systèmes d'Essuyage, Le Mesnil Saint Denis (FR)

(72) Inventors: Adrien Peret, Issoire (FR); Christophe Chassaing, Issoire (FR); Frederic Bretagnol, Issoire (FR)

(73) Assignee: Valeo Systèmes d'Essuyage, Le Mesnil Saint Denis (FR)

(21) Appl. No.: 18/288,720

(22) PCT Filed: Apr. 28, 2022
(86) PCT No.: PCT/EP2022/061308

§ 371 Date: Oct. 27, 2023

(30) Foreign Application Priority Data
Apr. 29, 2021 (FR) FR2104516

(51) Int. Cl. B60S 1/52; B60S 1/04; B60S 1/50; B60S 1/54

(52) U.S. Cl. CPC B60S 1/524; B60S 1/0408; B60S 1/50; B60S 1/546

(57) ABSTRACT

The invention relates to a wiper blade of a wiper system which extends in a longitudinal direction (L) and comprises at least one wiper strip that extends in the longitudinal direction, the wiper blade comprising at least a first channel (78), for the circulation of a first fluid, and a second channel (80), for the circulation of a second fluid, which extend longitudinally in the wiper blade, a connecting channel (82) extending between said channels (78, 80) in such a way that it fluidically connects the first channel with the second channel, the wiper blade being characterised in that it comprises at least one injection device (88) configured to inject the second fluid circulating in the second channel into the first fluid circulating in the first channel, the injection device being arranged at least partly in the connecting channel.

The invention relates to a wiper system intended to wipe glazed surfaces of a vehicle, for example a motor vehicle. More specifically, the invention relates to wiper systems that enable cleaning fluid to be projected onto the related glazed surface.

Typically, a wiper system intended to be fitted to a motor vehicle comprises at least one wiper blade designed to come into contact with a glazed surface such as the windshield of a motor vehicle and at least one wiper arm designed to drive the wiper blade in rotation. The wiper conventionally comprises a wiper rubber, generally made of rubber, designed to rub against the glazed surface of the vehicle in order to remove water and/or dirt from the driver's field of view. The wiper blade is carried by the arm, which is driven by a motor in an angular to-and-fro movement.

In order to improve the cleaning efficiency of the wiper blade on the glazed surface, it is known for the wiper systems currently in use to incorporate systems for projecting a cleaning liquid that are designed to project cleaning liquid onto the glazed surface to be wiped. However, known wiper blades can be improved upon, notably in that they do not provide optimum wettability of the glazed surface, while consuming a significant quantity of cleaning liquid.

The present invention addresses this issue and is intended to overcome the aforementioned drawbacks by proposing a more efficient wiper frame, i.e. a wiper frame providing better wettability of the glazed surface to be cleaned, while reducing the quantity of cleaning liquid required to clean the glazed surface.

The present invention thus relates to a wiper blade of a wiper system extending in a longitudinal direction and comprising at least one wiper rubber extending in the longitudinal direction, and a connection device intended to connect the wiper blade to an arm of the wiper system, the wiper blade comprising at least a first flow channel for a first fluid and a second flow channel for a second fluid that extend inside the wiper blade in the longitudinal direction, and a link channel extending between said channels to fluidly connect the first channel to the second channel, the wiper blade being characterized in that it comprises at least one injection device designed to inject the second fluid flowing through the second channel into the first fluid flowing through the first channel, the injection device being arranged at least partially inside the link channel.

The wiper system may be used in a vehicle, for example a motor vehicle, to clean a glazed surface of said vehicle. The wiper system comprises the arm which is driven in rotation by an electric motor of the vehicle and which provides the rotary movement of the wiper blade rigidly connected thereto by the connection device, against the glazed surface, so that the rubber carried by the wiper blade clears said glazed surface of raindrops and/or solid debris deposited on said surface.

The first channel and the second channel respectively enable the circulation of the first fluid, for example a cleaning liquid, and the second fluid, for example a gas, through the wiper blade. The wiper blade has a first longitudinal end and a second longitudinal end arranged opposite one another in the longitudinal direction of the wiper blade, the first channel and the second channel extending longitudinally from one longitudinal end to the other longitudinal end of said wiper blade.

The first flow channel can then be fluidly connected to a projection system enabling at least the first fluid to be sprayed against the glazed surface of the vehicle using a plurality of projection orifices formed in the wiper blade, such that said projection orifices are in fluid communication with the first channel and an environment outside said wiper blade, and aimed toward the glazed surface.

The link channel provides fluid communication between the first channel and the second channel via the injection device designed to spray the second fluid into the first channel containing the first fluid. More specifically and according to the example of the invention, the injection device is designed to inject the gas forming the second fluid into the cleaning liquid forming the first fluid.

This injection of the second fluid into the first fluid is used to foam the first fluid before said fluid is projected onto the glazed surface. The projection system in fluid communication with the first channel is designed to project the mixture comprising the first fluid and the second fluid against the glazed surface. This increases the wettability of the glazed surface while reducing the quantity of the first fluid required to clean said glazed surface.

According to one feature of the invention, the wiper blade comprises at least one air deflector that extends in the longitudinal direction, the first channel being formed at least partially inside said deflector. Advantageously, the first channel and the second channel are formed at least partially inside the deflector.

The deflector notably comprises a deflection surface arranged such that it is installed transverse to the air flow when the vehicle is moving. The deflector therefore improves the pressing of the wiper blade against the glazed surface using the deflection surface. According to one example of the invention, the wiper blade has two deflectors, each positioned on both sides of the connection device in the longitudinal direction of the wiper blade. Thus, a first air deflector extends between the connection device and the first longitudinal end of the wiper blade and a second air deflector extends between the connection device and the second longitudinal end of the wiper blade. Furthermore, the first channel and the second channel extend longitudinally inside the first deflector and the second deflector.

According to one feature of the invention, the wiper blade comprises at least one end member of the wiper blade arranged at a longitudinal end of the wiper blade, the first channel and the second channel extending at least partially inside the end member, said end member at least partially comprising the link channel and the injection device.

According to one example of the invention, the end member, also referred to as an end piece, is arranged at the first longitudinal end of the wiper blade. The first channel and the second channel are formed at least partially in the first deflector and in the end member arranged at said first longitudinal end of the wiper blade. The second fluid is injected into the first fluid by the injection device in the end member.

According to one example of the invention, the wiper blade may comprise a first end member and a second end member, arranged respectively at the first longitudinal end and the second longitudinal end of the wiper blade, and either the first end member or the second end member may comprise the link channel and the injection device.

According to an alternative of the invention, the connection device at least partially comprises the link channel and the injection device.

According to this alternative of the invention, the connection device comprises at least one connector and an adapter mounted rotatably on the connector, said connector comprising at least the link channel and the injection device.

The connector carries the wiper blade and receives the adapter mounted rotatably on the latter. In this alternative of the invention, the second fluid is injected into the first fluid in the connector. Thus, in this example of the invention, only the first channel extends as far as the longitudinal ends of the wiper blade, the second channel extending only inside the connector, where it joins the link channel, which is also fluidly connected to the first channel.

According to one feature of the invention, the injection device comprises at least one valve, at least one seat of the valve and at least one elastic return member that presses the valve against the seat.

The elastic return member is designed to be deformed then to return to a non-deformed state without breaking. The elastic return member may for example be a spring. The elastic return member may be rigidly connected to the valve, but does not have to be. Thus, in the non-deformed state, the elastic return member presses the valve against the related seat, thereby preventing the second fluid from entering the link channel. Conversely, when the elastic return member is in the deformed position, the valve is able to move away from the seat under the pressure of the second fluid, thereby allowing the second fluid to enter the link channel and the first channel.

According to one feature of the invention, the injection device comprises an injector formed by a restriction of a section of the link channel.

The injector is notably formed at a limit between the first channel and the link channel. The restricted section in the link channel enables the injector to increase the injection speed of the second fluid into the first fluid, such as to ensure the uniform mixing of said fluids in the first channel and to encourage foaming. Additionally, the injection speed promoted by the restricted section ensures that the second fluid reaches both longitudinal ends of the wiper blade, so that the foaming occurs over the entire glazed surface. This enables a uniform distribution of the second fluid in the first fluid before projection of the mixture onto the glazed surface using the projection system.

According to one feature of the invention, the connection device comprises at least a first inlet connected to the first channel and a second inlet connected to the second channel. The first inlet and the second inlet are fluidly connected respectively to the first channel and to the second channel. Advantageously, the first inlet and the second inlet are formed on the connector of the connection device.

According to one feature of the invention, the wiper blade has at least one projection system comprising a plurality of projection orifices distributed along the wiper blade, the projection system being connected to the first channel.

The projection system enables the mixture of the first fluid and the second fluid in the first channel to be projected onto the glazed surface.

The invention also relates to a wiper system for a glazed surface of a vehicle, comprising at least one wiper arm carrying a wiper blade according to any one of the aforementioned features by means of the connection device.

According to one features of the wiper system, said wiper system comprises at least one tank intended to contain the first fluid and a circulation pump for circulating the first fluid through a first circuit connecting the tank to a first inlet of the connector, the wiper system comprising at least one pressurization member for pressurizing the second fluid that is connected to a second inlet of the connector by a second circuit. The tank is intended to contain the cleaning liquid, while the pressurization member enables the gas, in this case air, in the second circuit and in the second channel to be pressurized. Furthermore, the pressurization member supplies air for the first channel, during use of the wiper system, by drawing air from the environment outside said wiper system.

According to one feature of the wiper system, the first circuit comprises at least one blocking member to prevent the second fluid from entering said first circuit. The blocking member is arranged on the first circuit between the pump and the first inlet of the connector to prevent the second fluid from flowing back into the tank containing the first fluid.

According to one feature of the wiper system, the second channel comprises at least one stop member to prevent the first fluid from entering the second channel.

The stop member helps to prevent the first fluid from flowing back into the second channel and obstructing the flow of the second fluid to the link channel, which could damage the wiper system.

According to one feature of the wiper system, the first fluid is a liquid and the second fluid is a gas. The first fluid is notably the cleaning liquid and the second fluid is air.

The invention also relates to a usage method for the wiper system according to any one of the aforementioned features, during which the pump is activated in a first step to circulate the first fluid from the tank to the link channel, and the pressurization member for pressurizing the second fluid is activated in a second step to combine the second fluid in the second flow channel with the first fluid in the first channel using the injection device, the second step being implemented after the first step.

The second step of the method has to be implemented after the first step so that the second fluid does not prevent the first fluid from flowing to the link channel. Furthermore, such a method enables the second fluid to be mixed with the first fluid, thereby enabling a lesser quantity of first fluid to be projected against the glazed surface, without diminishing the cleaning capacity of the first fluid. In other words, the usage method for the wiper system helps to increase the wettability of the glazed surface while reducing the quantity of first fluid used, by creating a foam in the first channel, before projection onto the glazed surface.

Further features, details and advantages of the invention will become more clearly apparent from reading the description given below by way of indication with reference to the drawings in which:

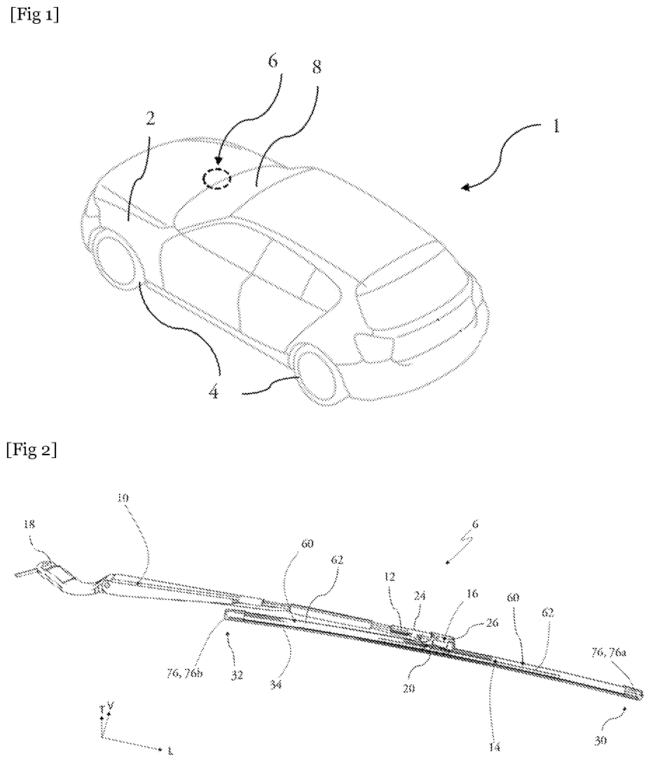

FIG. 1 is a front view of a motor vehicle comprising at least one wiper system according to the invention,

FIG. 2 is a perspective view of at least a portion of the wiper system in FIG. 1 showing a wiper blade connected to a wiper arm using a connection device,

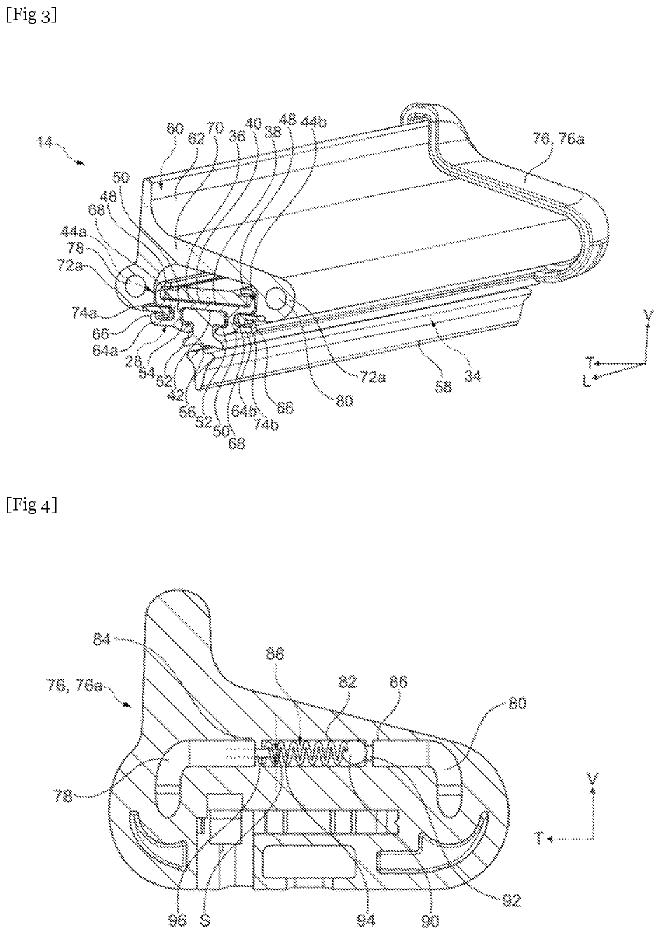

FIG. 3 is a cross section view of the wiper blade in FIG. 2 showing a first flow channel for a first fluid and a second flow channel for a second fluid,

FIG. 4 is a cross section view of an end member of the wiper blade comprising at least one link channel between the first channel and the second channel,

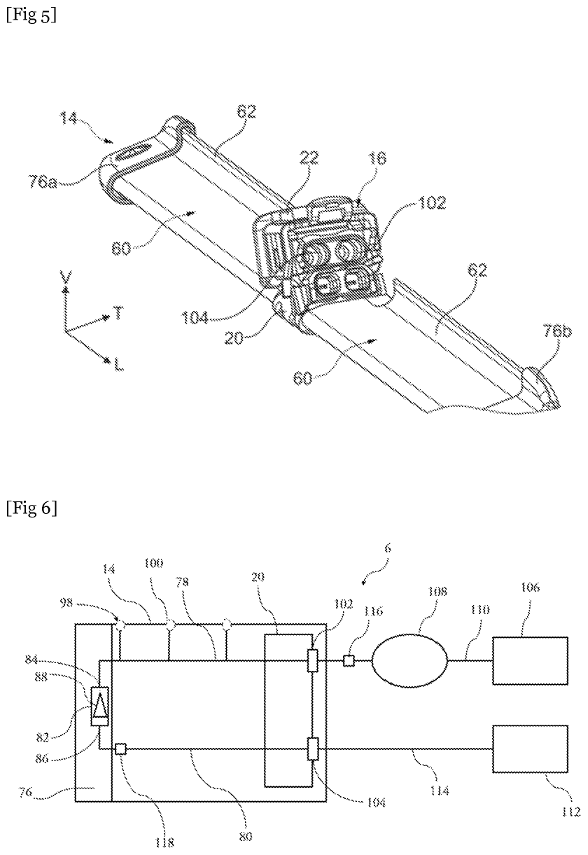

FIG. 5 is a perspective view of the wiper blade in FIG. 2 showing a connector and an adapter of the connection device,

FIG. 6 is a schematic view of the wiper system in FIG. 1 comprising at least a tank and a pump that are connected to the first channel and a pressurization member connected to the second channel,

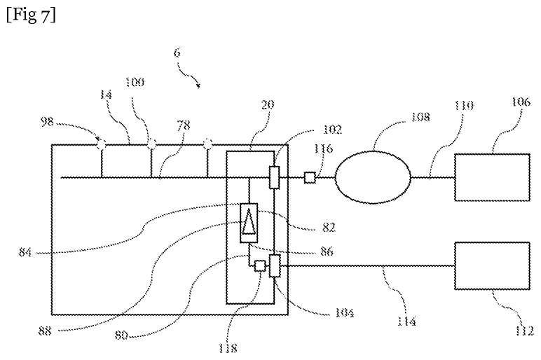

FIG. 7 is a schematic view of an alternative of the wiper system in FIG. 1 in which the link channel and the injection device are formed in the connector of the connection device.

It should first of all be noted that, while the figures set out the invention in detail for the implementation thereof, it will be appreciated that these figures may be used to define the invention better, where appropriate. It should also be noted that these figures merely show example embodiments of the invention. Lastly, the same references denote the same elements throughout the figures.

FIG. 1 shows a vehicle 1, in this case a motorcar, comprising at least a body 2 and four wheels 4, of which only two are visible here, said wheels 4 being used to move the vehicle 1. The vehicle 1 also has at least one wiper system 6 for cleaning a glazed surface 8, in this case a windshield 8, to improve a driver's view of the road in front of the vehicle 1, in rainy weather for example, or for the purpose of clearing away solid debris sticking to said glazed surface 8.

The wiper system 6 shown at least partially in FIG. 2 extends in a main direction, in this case a longitudinal direction L, and has at least one wiper arm 10 comprising at least a free end 12 carrying a wiper blade 14 using a connection device 16, and a link end 18, opposite the free end 12 in the longitudinal direction L of the wiper system 6, connected to the vehicle. The arm 10 and the wiper blade 14 both extend in a main lengthwise direction identical to the direction of the wiper system 6, in this case the longitudinal direction L. The wiper blade 14 is also notably adapted for being driven in rotation by the wiper arm 10 against the glazed surface of the vehicle, said arm being linked in rotation to a motor (not shown), for example an electric motor carried on the vehicle.

The connection device 16 used to link the wiper blade 14 to the free end 12 of the arm 10 comprises a connector 20 carrying the wiper blade 14 and an adapter 22 mounted rotatably on the connector 20, the adapter 22 being for example designed to cooperate with a yoke 24 of the arm 10 formed at the free end 12 thereof. The connector 20 is notably arranged on the wiper blade 14 substantially centrally in the longitudinal direction L of said wiper blade 14. A cover 26 can also cover the connection device 16 to provide mechanical protection against external elements that could be interposed between the connector 20 and the adapter 22.

The wiper blade 14, shown in FIGS. 2 and 3, comprises a structural support 28 extending longitudinally between a first longitudinal end 30 and a second longitudinal end 32, and is designed to carry a wiper rubber 34, for example made of rubber, and at least one stiffening spine 36 to stiffen the wiper blade 14 while enabling the bending required for the wiper rubber 34 to be pressed against the glazed surface. According to one example of the invention, the wiper blade 14 may comprise a single stiffening spine 36 or two stiffening spines 36 arranged in a shared plane. The stiffening spines 36 thus extend longitudinally between the first longitudinal end 30 and the second longitudinal end 32 of the structural support 28, passing through the connection device 16, notably in the connector. Similarly, the wiper rubber 34 extends longitudinally between the first longitudinal end 30 and the second longitudinal end 32 of the structural support 28 of the wiper blade 14. The structural support 28 comprises at least one plateau 38 extending mainly in a plane L, T, said plateau 38 comprising at least an upper face 40 in contact with the stiffening spine 36 and a lower face 42 facing toward the wiper rubber 34. The structural support 28 is a member that provides a mechanical link between the stiffening spine 36 and the wiper rubber 34.

The structural member 38 comprises a first retaining member 44a and a second retaining member 44b extending from the plateau 38, and enabling the at least one stiffening spine 36 to be gripped. More specifically, the first retaining member 44a and the second retaining member 44b form claws that link the at least one stiffening spine 36 to the structural support 28. A second portion 48 extends each of the first portions 46 perpendicularly so that the second portions 48 are folded over the at least one stiffening spine 36. These claws folded over the at least one stiffening spine 36 prevent movements between said stiffening spine and the structural support 28 in a vertical direction V perpendicular to the longitudinal direction L and the transverse direction T of the wiper blade 14, and also in the transverse direction T.

The lower portion of the structural support 28, opposite the stiffening spine 36, is designed to carry the wiper rubber 34 of the wiper system 6. For this purpose, two fingers 50 extend principally in the longitudinal direction L and emerge perpendicularly from the plateau 38, opposite the stiffening spine 36. Each finger 50 has a finger end 52 folded perpendicularly toward the other finger end 52 to form a seat 54 for a heel 56 of the wiper rubber 34. In other words, each of the finger ends 52 extends substantially perpendicularly from one of the fingers 50 such as to prevent the heel 56 from coming out of the wiper rubber 34 in the vertical direction V. A lip 58 of the wiper rubber 34 that is intended to be in contact with the glazed surface of the vehicle extends opposite the heel 56 of the wiper rubber 34.

The wiper blade 14 can also have at least one deflector 60 comprising a deflection surface 62, said deflector 60 being connected to the structural support 28 of the wiper blade 14. According to the illustrated example of the invention, the wiper blade 14 has two deflectors 60 aligned in series on both sides of the connection device 16, and notably of the connector 20. Each of the deflectors 60 extends from the connection device 16 to either the first longitudinal end 30 or the second longitudinal end 32 of the wiper blade 14. The deflection surface 62 of each of the deflectors 60 is designed so that, when the wiper system 6 is installed on the vehicle, the deflection surface 62 extends across the path of the air flow when the vehicle is in motion. The deflectors 60 are intended to improve the pressing of the wiper blade 14 against the glazed surface using the force of the air flow generated on the deflection surface 62.

To rigidly connect the deflector 60 to the structural support 28 of the wiper blade 14, said structural support 28 has a first lug 64a and a second lug 64b designed to form an engagement zone to fasten the deflector 60. The first lug 64a and the second lug 64b each extend substantially perpendicularly from the fingers 50 of the structural support 28, and in opposite directions from one another toward the environment outside the structural support 28. Each of the lugs 64a, 64b has a raised edge 66 extending substantially perpendicularly from the lug 64a, 64b and toward the plateau 38 of the structural support 28 of the wiper blade 14, such as to form a cavity 68 for receiving a portion of the deflector 60.

More specifically, the deflector 60 has at least one base 70 that covers at least the stiffening spine 36 of the wiper blade 14 and from which the deflection surface 62 extends substantially perpendicularly, opposite the structural support 28 of the wiper blade 14. The deflector 60 further comprises a first side wall 72a and a second side wall 72b, each of which extends substantially perpendicularly from the free transverse ends of the base 70. More specifically, the first side wall 72a and the second side wall 72b extend opposite the first retaining member 44a and the second retaining member 44b respectively of the stiffening spine 36. The side walls 72a, 72b also extend in the longitudinal direction L, over the entire length of the deflector 60.

The first side wall 72a and the second side wall 72b are each extended at the free end thereof respectively by a first tooth 74a and a second tooth 74b. The first tooth 74a and the second tooth 74b each extend substantially perpendicularly from the end of one of the side walls 72a, 72b toward the wiper rubber 34. Furthermore, in consideration of the foregoing, the first tooth 74a and the second tooth 74b are designed to be seated in a space delimited by the lugs 64a, 64b, the plateau 38 and each of the raised edges 66 of the lugs 64a, 64b. This enables the position of the deflector 60 to be blocked in the vertical direction V and the transverse direction T of the wiper blade 14.

To block the position of the at least one stiffening spine 36, the wiper rubber 34 and a deflector 60, in relation to the structural support 28 of the wiper blade 14 in the longitudinal direction L thereof, the wiper blade 14 comprises at least one end member 76 positioned at one of the longitudinal ends 30, 32 thereof. According to the illustrated example of the invention shown in FIG. 2, the wiper blade comprises a first end member 76a and a second end member 76b, positioned respectively at the first longitudinal end 30 and the second longitudinal end 32 of the wiper blade 14.

According to the invention, the wiper blade 14 comprises at least a first flow channel 78 for a first fluid and a second flow channel 80 for a second fluid that extend longitudinally in the wiper blade 14. More specifically, and as shown in particular in FIG. 3, the first channel 78 and the second channel 80 extend longitudinally in the material of the deflector 60, respectively in the first side wall 72a and the second side wall 72b, which then form lateral beads. The first channel 78 and the second channel 80 then extend longitudinally into at least one of the end members 76 of the wiper blade 14, in this case the first end member 76a, as shown in FIG. 4.

Again according to the invention, the wiper blade 14 comprises at least one link channel 82 that extends between the first channel 78 and the second channel 80 to fluidly connect the first channel 78 to the second channel 80. More specifically and as shown in particular in FIG. 4, a first terminal end 84 of the first channel 78 and a second terminal end 86 of the second channel 80 are arranged opposite and away from one another so that the link channel 82 extends between the first terminal end 84 and the second terminal end 86.

According to a first embodiment of the invention, the link channel 82 in formed in at least one of the end members 76 of the wiper blade 14, in this case the first end member 76a. Furthermore, the link channel 82 can be formed in the second end member 76b of the wiper blade 14, or each end member 76a, 76b has its own link channel 82 fitted with an injection device

According to the invention, the wiper blade 14 comprises at least one injection device 88 designed to inject the second fluid flowing through the second channel 80 into the first fluid flowing through the first channel 78, the injection device 88 being arranged at least partially inside the link channel 82. Thus, in the example of the invention shown in FIG. 4, the first end member 76a comprises the link channel 82 and the injection device 88.

The injection device 88 according to the invention comprises at least one valve 90, a seat 92 of the valve 90, an elastic return member 94 that presses the valve 90 against the seat 92, and at least one injector 96. The seat 92 is formed in the second terminal end 86 of the second channel 80 and is shaped to fit the valve 90 so that contact between the seat 92 and the valve 90 fluidly plugs the second terminal end 86 of the second channel 80. According to the example of the invention shown in FIG. 4, the valve 90 has a spherical shape designed to cooperate with the cylindrical shape of the second terminal end 86 of the second channel 80 forming the seat 92 of the valve 90.

The contact between the valve 90 and the seat 92 is made by the elastic return member 94, in this case a spring, that is for example rigidly connected to the valve 90 and designed to be deformed and then to return to the original shape without breaking. In the original shape, the elastic return member 94 presses the valve 90 against the seat 92, and when in the compressed shape the elastic return member 94 enables the valve 90 to move away from the seat 92 to enable the second fluid to enter the link channel 82. According to the invention, the elastic return member 94 can be compressed if the pressure exerted by the second fluid against the valve 90 exceeds the resistance to deformation of the elastic return member 94.

As shown in FIG. 4, the injector 96 is formed by a restriction of a section S of the link channel 82 in a plane L, V. More specifically, the restriction of the section S of the link channel 82 is formed at the boundary between the link channel 82 and the first terminal end 84 of the first channel 78. Such an arrangement of the injector 96 increases the movement speed of the second fluid at the outlet of said injector 96.

Such an arrangement of the injection device 88 is advantageous in that it optimizes the injection of the second fluid into the first fluid flowing through the first channel 78. Notably, where the first fluid is a liquid, for example a cleaning liquid, and where the second fluid is a gas, for example air, the gas is uniformly mixed into the cleaning liquid to foam said cleaning liquid. Such mixing of the cleaning liquid with the gas is also advantageous where the wiper blade has at least one projection system 98, shown in FIGS. 6 and 7, connected to the first channel 78 and designed to project at least one fluid against the glazed surface of the vehicle.

This projection system 98 of the wiper blade 14 comprises a plurality of projection orifices 100 distributed along the wiper blade 14 in the longitudinal direction L thereof, such that each projection orifice 100 opens into the first channel 78 and an environment outside said wiper blade 14. Each of the projection orifices 100 is oriented toward the glazed surface of the vehicle such that the at least one fluid flowing through the first channel 78 is projected onto the glazed surface, to help with cleaning.

In consideration of the foregoing, the injection device 88 foams the cleaning liquid by injecting the gas into the cleaning liquid, which increases the wettability of the glazed surface to be cleaned, while reducing the quantity of cleaning liquid required to clean the dirt from the glazed surface.

As shown in FIGS. 5 and 6, the connector 20 comprises at least a first inlet 102 fluidly connected to the first channel 78 and a second inlet 104 fluidly connected to the second channel 80. The first inlet 102 and the second inlet 104 are the entry points for the first fluid and the second fluid into the wiper blade 14.

Furthermore and as shown in FIG. 6, the wiper system has at least one tank 106 intended to contain the first fluid, as well as a circulation pump 108 for circulating the first fluid within a first circuit 110 that connects the tank 106 to the first inlet 102 of the connector 20. The first fluid is intended to be stored inside the tank 106, before being circulated by the pump 108 through the first circuit 110 and passing through the first inlet 102 into the first channel 78, in which the fluid flows to the link channel 82 and is blocked by the injection device 88, enabling the fluid to be projected onto the glazed surface of the vehicle by the aforementioned projection system 98.

Again in FIG. 6, the wiper system 6 has at least one pressurization member 112, for example a compressor 112, for pressurizing the second fluid that is connected to the second inlet 104 of the connector 20 by a second circuit 114. The compressor 112 enables the second fluid, in this case air, to be pressurized such as to flow under pressure through the second circuit 114 to the second inlet 104 of the connector 20 then through the second channel 80 of the wiper blade 14, at least as far as the second terminal end 86 of said second channel 80. The pressurized second fluid then exerts a pushing force against the valve of the injection device 88 that is greater than the resistance to deformation of the elastic return member 94 added to the force resulting from the pressure of the first fluid on the valve 90, which tends to compress the elastic return member 94, thereby enabling the second fluid to flow into the link channel 82 then through the injector 96 to be mixed with the first fluid flowing through the first channel 78.

According to an example embodiment of the invention shown in FIG. 6, the wiper system 6 may comprise at least one blocking member 116 to prevent the second fluid from entering said first circuit 110. More specifically, the blocking member 116 is arranged between the pump 108 and the first inlet 102 of the connector 20 to prevent the second fluid from entering the first-fluid tank 106 and the pump 108, which could prejudice operation of the wiper system 6.

Furthermore, the wiper system 6 may have at least one stop member 118 to prevent the first fluid from entering the second channel 80. More specifically, the stop member 118 is arranged between the second inlet 104 of the connector 20 and the second terminal end 86 of the second channel 80 to limit the ingress of the first fluid into the second channel 80, which could reduce the injection efficiency of the second fluid into the first fluid, and damage the wiper system 6. According to a nonlimiting example of the invention, the blocking member 116 and the stop member 118 may be check valves that enable a fluid to flow in one direction and prevent a fluid from flowing in the other direction.

A second embodiment of the invention is described below with reference to FIG. 7. All of the structural and functional features of the first embodiment apply mutatis mutandis to the second embodiment of the invention, and only those features of the second embodiment that differ from the first embodiment are included in the description below. As regards the features in common, reference should be made to FIGS. 1 to 6.

In this second embodiment of the invention, the connection device 16 at least partially comprises the link channel 82 and the injection device 88. More specifically, the connector 20 of the connection device 16 comprises at least the link channel 82 and the injection device 88. Therefore, in this second embodiment of the invention, the second channel 80 extends at least partially into the connector 20, between the second inlet 104 and the link channel 82, and only the first channel 78 is formed inside one of the side walls of the deflector, as described above. Furthermore, the stop member 118 is arranged in the second channel 80, positioned inside the connector 20 between the second inlet 104 and the link channel 82 and performing a function similar to the first embodiment of the invention.

Finally, a usage method for the wiper system 6 is described below with reference to FIGS. 1 to 6. The usage method comprises at least one preliminary step in which a user of the vehicle 1 commands the cleaning of the glazed surface 8 of said vehicle 1. The usage method for the wiper system 6 uses an electronic control unit of said wiper system 6, which is not described in detail in this application.

Following this cleaning command for the glazed surface 8, which triggers movement of the wiper blade 14, the pump 108 is activated in a first step to circulate the first fluid from the tank 106 to the first terminal end 84 of the first channel 78, at the boundary with the link channel 82, i.e. passing through the first inlet 102 of the connector 20 then into the first channel 78 of the wiper blade 14. The pressurization member 112 for pressurizing the second fluid is then activated in a second step such that the second fluid, in this case air, in the second flow channel 80 is combined with the first fluid in the first channel 78 by the injection device 88. More specifically, the pressurization device 112 enables the second fluid in the second channel 80 to be pressurized so that said second fluid exerts a pushing force against the valve 90 of the injection device 88 that is greater than the force generated by the elastic return member 94, in order to compress the latter. Such a deformation of the elastic return member 94 releases the valve 90 from the seat 92 and thus fluidly opens the second terminal end 86 of the second channel 80. This enables the second fluid to flow from the second channel 80 to the link channel 82 then through the injector 96, which increases the movement speed of the second fluid so that the latter mixes uniformly with the first fluid throughout the first channel 78.

This ensures that the second fluid is mixed with the first fluid throughout the first channel 78, thereby enabling a uniform distribution of this mixture on the glazed surface 8 using the plurality of projection orifices 100. The mixture is considered to be uniform since the first fluid is ejected as foam over the entire length of the first channel 78. Such a mixture of the first fluid with the second fluid also advantageously increases the wettability of the glazed surface 8 to be cleaned, while reducing the quantity of the first fluid required to do so.

It should also be noted that the second step is only carried out once the first step has been completed. Indeed, the first fluid needs to be flowing in the first channel 78 before the second fluid is pressurized in the second channel 80 so as to guarantee the presence of the first fluid in the wiper blade before the second fluid is injected.

The invention as it has just been described is not, however, limited to the means and configurations exclusively described and illustrated, but also applies to all equivalent means or configurations and to any combination of such means or configurations.

1. A wiper blade of a wiper system,
wherein the wiper system extends in a longitudinal direction and comprises:
at least one wiper rubber extending in the longitudinal direction; and
a connection device intended to connect the wiper blade to an arm of the wiper system,
the wiper blade comprising:
at least a first flow channel for a first fluid;
a second flow channel for a second fluid,
wherein the first and second flow channels extend inside the wiper blade in the longitudinal direction;
a link channel extending between the first and second flow channels to fluidly connect the first channel to the second channel; and
at least one injection device designed to inject the second fluid flowing through the second channel into the first fluid flowing through the first channel,
wherein the injection device is arranged at least partially inside the link channel.

2. The wiper blade as claimed in claim 1, comprising at least one air deflector that extends in the longitudinal direction,
wherein the first channel is formed at least partially inside the deflector.

3. The wiper blade as claimed in claim 1,
comprising at least one end member of the wiper blade arranged at a longitudinal end of the wiper blade,
wherein the first channel and the second channel extending extend at least partially inside the end member,
wherein the end member at least partially comprises the link channel and the injection device.

4. The wiper blade as claimed in claim 1,
wherein the connection device at least partially comprises the link channel and the injection device.

5. The wiper blade as claimed in claim 4,
wherein the connection device comprises at least one connector and an adapter mounted rotatably on the connector,
wherein the connector comprises at least the link channel and the injection device.

6. The wiper blade as claimed in claim 1,
wherein the injection device comprises;
at least one valve;
at least one seat of the valve; and
at least one elastic return member that presses the valve against the seat.

7. The wiper blade as claimed claim 1,
wherein the injection device comprises an injector formed by a restriction of a section of the link channel.

8. A wiper system for a glazed surface of a vehicle, wherein the wiper system comprising at least one wiper arm carrying a wiper blade as claimed in claim 1.

9. The wiper system as claimed in claim 8,
comprising at least one tank intended to contain the first fluid and a circulation pump for circulating the first fluid through a first circuit connecting the tank to a first inlet of the connector;
the wiper system further comprising at least one pressurization member for pressurizing the second fluid that is connected to a second inlet of the connector by a second circuit.

10. A usage method for the wiper system as claimed in claim 8,
wherein the pump is activated in a first step to circulate the first fluid from the tank to the link channel, and the pressurization member for pressurizing the second fluid is activated in a second step to combine the second fluid in the second flow channel with the first fluid in the first channel using the injection device, the second step being implemented after the first step.
